(19) United States
(12) Patent Application Publication
(10) Pub. No.: US 2006/0221637 A1
(43) Pub. Date: Oct. 5, 2006

(54) Light source module, backlight unit, and liquid crystal display device

(75) Inventors: Hiroshi Chikugawa, Higashihiroshima-shi (JP); Masaaki Katoh, Higashihiroshima-shi (JP); Masayuki Ito, Mihara-shi (JP); Tsukasa Inoguchi, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/396,149

(22) Filed: Mar. 30, 2006

(30) Foreign Application Priority Data
Mar. 31, 2005 (JP) 2005/104900

(51) Int. Cl. F21V 7/04

(52) U.S. Cl. 362/612

(57) ABSTRACT

A light source module of the present invention includes: a first luminous element for emitting light having two peak wavelengths; and a second luminous element for emitting light having a single peak wavelength. With this configuration, it is possible to downsize the light source module, and improve a color reproducibility via a color filter.

This Nonprovisional application claims priority under 35 U.S.C. § 119(a) on Patent Application No. 2005/104900 filed in Japan on Mar. 31, 2005, the entire contents of which are hereby incorporated by reference.

### FIELD OF THE INVENTION

The present invention relates to a backlight unit and/or a light source module for use in a liquid crystal display device or the like.

### BACKGROUND OF THE INVENTION

A study has been conducted for developing a method of utilizing an LED (Light Emitting Diode) for manufacturing a white light source used in a backlight unit. As an example of such a method, the following methods are known. Namely, one of them is a method using a luminescence material, and another is a method in which a plurality of monochromatic LEDs are used. As illustrated in FIG. 10, in the former method in which the luminescent material is used, a luminescent material is used for producing white light, by converting radiated light from an LED (B chip) of ultraviolet to blue color, into yellow, green, red or the like. Meanwhile, in the latter method using a plurality of monochromatic LEDs, a plurality of LEDs (amongst a red-color LED, blue-color LED, and a green-color LED) are lighted for producing white color.

Here, related art to this invention is disclosed in Japanese Unexamined Patent Publications: No. 2002-16290 (Tokukai 2002-16290; Published on Jan. 18, 2002); No. 351789/2001 (Tokukai 2001-351789; Published on Dec. 21, 2001); No. 313424/2001 (Tokukai 2001-313424; Published on Nov. 9, 2001); No. 30877/2000 (Tokukai 2000-30877; Published on Jan. 28, 2000); and No. 321914/1998 (Tokukaihei 10-321914; Published on Dec. 4, 1998).

However, in the method using a luminescence material, the wavelengths of the green and red are significantly weakened. This, along with an unevenness in application of the luminescence material, causes significantly low color reproducibility via a color filter.

Further, the method of using a plurality of monochromatic LEDs have the following problems. For example, it is assumed that two LEDs (e.g. blue-color LED and green-color LED) are used. In this case, a circuit configuration can be made simple and small. However, the absence of a red-color causes a low color reproducibility via the color filter (See FIG. 11). It is possible to maintain a good color reproducibility via the color filter, by using three LEDs (e.g. blue-color, green-color, and red-color LEDs). This configuration, however, complicates the circuit, and requires a larger area for the LEDs. As a result, the light source module is inevitably enlarged. This enlargement of the light source module is particularly unacceptable in a small or medium size liquid crystal display device which is used in a mobile phone, an instrumental panel of an automobile, or the like.

### SUMMARY OF THE INVENTION

The present invention is made in view of the foregoing problems, and it is an object of the present invention to provide a light source module for a backlight unit which realizes a high color reproducibility via a color filter, and which is being capable of being downsized.

In order to solve the foregoing object, a light source module of the present invention is a light source module for use in a backlight unit of a display device, including a luminous element for emitting light having at least two peak wavelengths. In the configuration, a light of two colors (e.g. blue and green) is produced with the use of the single luminous element. By mixing the two colors, white light is obtained. In this configuration, a circuit for driving (causing light emission from) the luminous element can be made smaller than that of a light source module including only monochromatic luminous elements. Thus, it is possible to downsize the light source module. Further, since the circuit can be made smaller (simpler), it is possible to add (additionally mount) a luminous element of another color. This allows production of white light by mixing three colors (e.g. blue, green, and red). As a result, it is possible to improve the reproducibility of colors via a color filter.

### BRIEF DESCRIPTION OF THE DRAWINGS

FIG. 1 is an exploded perspective view illustrating a configuration of a backlight unit, in accordance with the present invention.

FIG. 2 is a schematic view illustrating a configuration of an LED light source, in accordance with the present invention.

FIG. 3 is a schematic view illustrating an alternative configuration of an LED light source, in accordance with the present invention.

FIG. 4 is a perspective view illustrating a configuration of a two-wavelength LED chip which is used in the LED light source of the present invention.

FIG. 5 is a diagram explaining how currents If-1, If-2, and V1 change over time, in the LED light source illustrated in FIG. 2.

FIG. 6 is a diagram explaining how currents IF-1, IF-2, and V1 change over time, in the LED light source illustrated in FIG. 3.

FIG. 7 is a graph indicating respective properties of the luminous wavelengths of LEDs in the present invention, and property of light transmitted through a color filter.

FIGS. 8(a) to 8(c) are perspective views, each illustrating a configuration of a concave portion in the LED light source of the present invention.

FIG. 9 is a perspective view illustrating another configuration of the concave portion in the LED light source of the present invention.

FIG. 10 is an exploded perspective view illustrating a configuration of a conventional backlight unit.

FIG. 11, is a graph indicating the luminous wavelength of the LEDs in a conventional art, and characteristics of light transmitted through a color filter.

### DESCRIPTION OF THE EMBODIMENTS

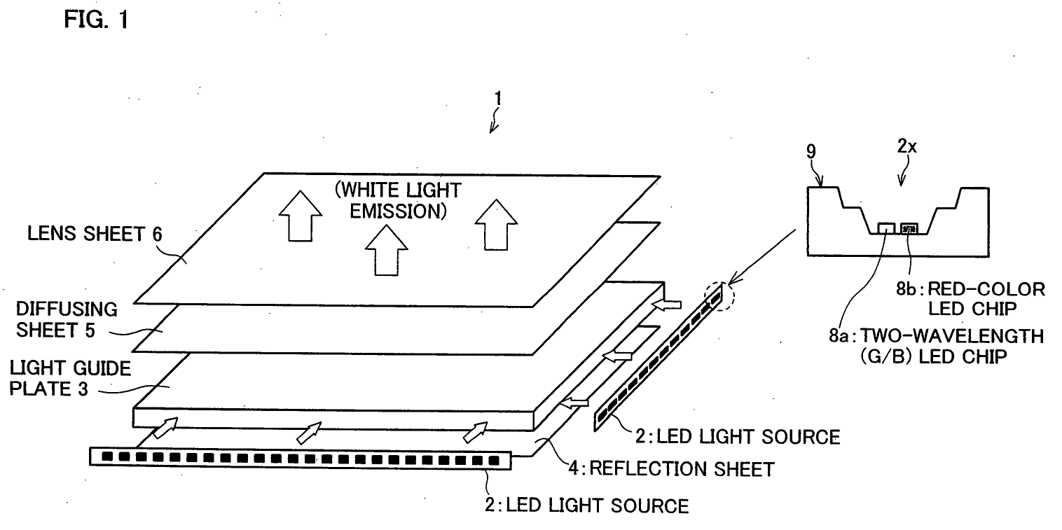

The following describes, with reference to FIG. 1 to FIG. 9, an embodiment of the present invention. FIG. 1 is an exploded perspective view illustrating a configuration of a backlight unit (for use in an instrumental panel of an automobile), in accordance with the present invention. As illustrated in the figure, the backlight unit 1 includes: an LED (light-emitting diode) light source 2 (light source module), a reflection sheet 4, a light guide plate 3, a diffusing sheet 5 and a lens sheet 6. Further, the LED light source 2 includes: at least one module substrate 9, at least one two-wavelength LED chip 8a, at least one red color LED chip 8b; and a light source control circuit (not shown).

The LED light source 2 is placed along a plane-directional edge of the flat light guide plate 3. In the backlight unit 1, the reflection sheet 4, the light guide plate 3, the diffusing sheet 5, and the lens sheet 6 are laminated in this order. Further, a display panel (not shown) including a color filter (not shown) is provided on the top layer which is the lens sheet 6. The light guide plate 3, in cooperation with the reflection sheet 4, diffuses the light from the LED light source 2 through out the entire surface of the light guide plate 3, the LED light source 2 being placed at the edge of the light guide plate 3. The diffusing sheet 5 diffuses the light from the light guide plate 3, and equalize the intensity of components of the light directed in various directions. Further, the lens sheet 6 directs the diffused light from the diffusing sheet 5 to a direction towards the display panel (i.e. towards the normal direction of the lens sheet 6).

A plurality of depressed portions 2x are formed on the module substrate 9, and as illustrated in the magnified view in FIG. 1, the two-wavelength LED chip 8a and the Red color LED chip 8b are provided at the bottom of the each of the depressed portions 2x. The structural relationship amongst the module substrate 9, the depressed portions 2x, and the LED chips 8a and 8b is described in detail later.

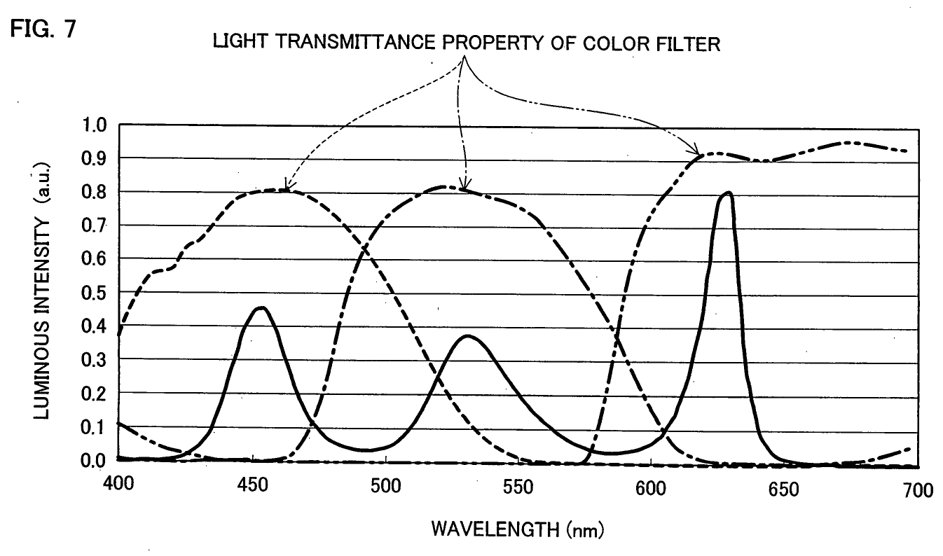

The two-wavelength LED chip 8a is an LED (Light Emitting Diode) which emits light having two peak wavelengths. Such a two-wavelength LED chip 8a emits light of two colors of blue and green. In other words, the light from the two-wavelength LED mainly includes a wavelength of the blue region and a wavelength of the green region. FIG. 7 illustrates respective luminescence properties of the two-wavelength LED chip 8a and the red color LED chip 8b. As illustrated in the figure, main wavelengths (peak wavelengths) of the light emitted from the two-wavelength LED chip 8a are a wavelength of nearby 450 [nm] and a wavelength of nearby 530 [nm]. Meanwhile, a main wavelength (peak wavelength) of the light emitted from the red color LED chip 8b is nearby 625 [nm]. The light from the two-wavelength LED chip 8a is mixed with the light from the red color LED 8b, thus producing white light. Further, as illustrated in FIG. 7, the peak wavelengths of the light substantially match with the peak wavelengths which are transmitted through a color filter (three colors of R, G, and B). Thus, the LED light source 2 of the present embodiment realizes a high level of color reproduction (i.e. enables reproduction of a wider range of colors).

Here, the LED light source 2 includes a plurality of depressed portions 2x, each of which being provided with one two-wavelength LED chip 8a and one red color LED chip 8b. The number of the depressed portions 2x varies, depending on (i) the usage of the backlight unit 1, and (ii) the luminance of the LED chips 8a and 8b. For example, in the backlight unit 1 of FIG. 1 for use in an instrument panel of an automobile or the like, thirty-six depressed portions 2x are provided along the edges (2 lines which are adjacent to each other) of the light guide plate 3. In short, the light source module 2 includes: thirty-six two-wavelength LED chips 8a and thirty-six red color LED chips 8b.

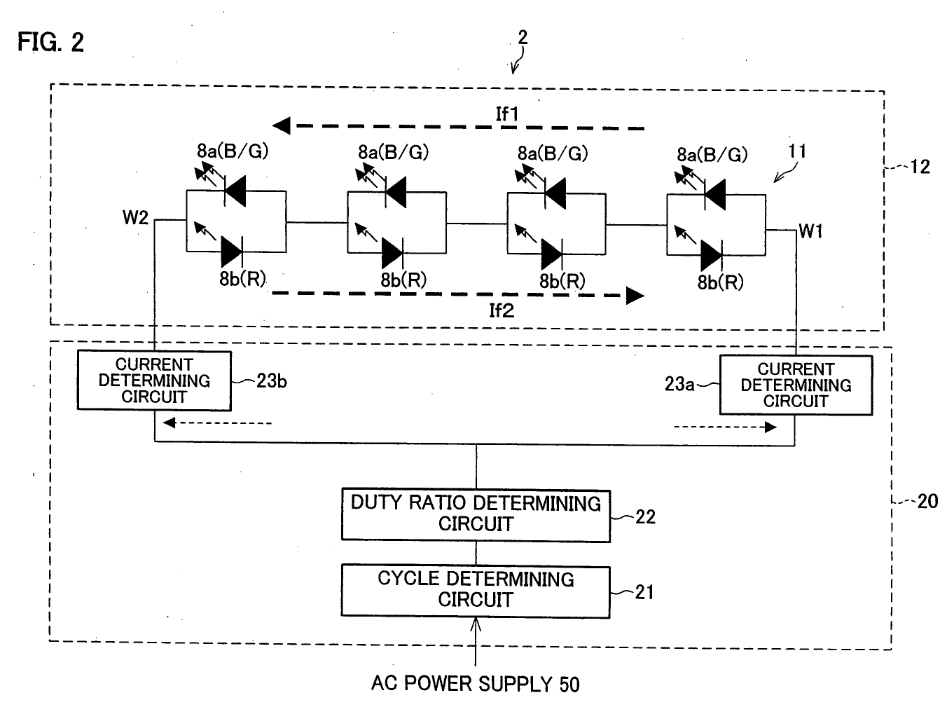

FIG. 2 is a circuit diagram illustrating a relationship of connection amongst the LED chips 8a and 8b, and the light source control section. In FIG. 2, four depressed portions are provided; i.e. four two-wavelength LED chips 8a and four red color LED chips 8b are provided. As illustrated in the figure, in each of the depressed portions 2x, one two-wavelength LED chip 8a and one red color LED chip 8b are connected in parallel between two nodes so that the respective electric polarities (anode-to-cathode directions) of the LEDs 8a and 8b are opposite to each other. The LEDs 8a and 8b form a unit light-emitting circuit 11. Further, four of the unit light-emitting circuits 11 are respectively formed the four depressed portions 2x, and are serially connected with each other to form a light-emitting circuit 12. Thus, in the LED light source 2 of the present embodiment, the light-emitting circuit 12, which includes the four unit light-emitting circuits 11 being serially connected with one another, is connected to the light source control circuit 20 via nodes W1 and W2. The light source control circuit 20 includes: a cycle determining circuit 21; a duty ratio determining circuit 22 (determining circuit); and two current determining circuits 23a and 23b (adjustment circuit).

AC power supply 50 generates an AC voltage of a block pulse, and outputs the AC voltage to the cycle determining circuit 21. The cycle determining circuit 21 determines the cycle (a predetermined period) of the block pulse at 1.0 ms or the like. The electric potentials at the nodes W1 and W2 are alternately switched between a positive and a negative potentials. As a result, a current If1 and a current If2, whose respective flowing directions are opposite to each other, alternately flow in the light emitting circuit 12. FIG. 5 is a diagram explaining how the currents If1 and If2, and V1 changes over time, the V1 being the electric potential of the node W1. It is assumed that: a period in which the current If1 flows is a time period t1; a period in which the current If2 flows is a time period t2; and a sum of the time periods t1 and t2 is T. As illustrated in the figure, the electric potential V1 is positive potential during the time period t1, and the current If1 flows. As a result, each of the two-wavelength LED chips 8a are lit up. During the time t2 which is subsequent to the time period t1, the electric potential V1 is the negative potential, and the current If-2 flows. As a result, each of the red color LED chips 8b are lit up. Thus, a duty ratio of the current If1 is t1/T, and that of the current If2 is t2/T.

The duty ratio determining circuit 22 determines: (i) how long the current If1 flows in the LED chips 8a, within one cycle; and (ii) how long the current If2 flows in the LED chips 8b, within one cycle. For example, the period during which the current If1 flows is determined at 0.8 ms, and the period during which the current If2 flows is determined at 0.2 ms. More specifically, the duty ratio of the If1 (i.e. the period during which the current flows in the two-wavelength LED chip 8a/one cycle) is determined at 0.8, and the duty ratio of the If2 (i.e. a period during which the current flows in the LED chip 8b one cycle) is determined at 0.2.

Here, for example, the current determining circuit 23a is configured by a variable resistor. This current determining circuit 23a adjusts a value of the current If1 which flows in the two-wavelength LED chip 8a. Further, for example, the current determining circuit 23b is configured by a variable resistors. This current determining circuit 23b adjusts a value of the current If2 which flows in the red color LED chip 8b (described later). Further, the duty ratio determining circuit 22 adjusts an average current value flowing in the LED chips 8a and 8b, by varying the duty ratios t1/T and t2/T. A chromaticity of light emitted from the LED chips 8a and 8b varies, in accordance with a variation in the average current value. Thus, by varying the duty ratios t1/T and t2/T so that a desirable white light is obtained, it is possible to desirably determine the chromaticity.

In the light emitting circuit 12, the two-wavelength LED chip 8a has oscillation peak wavelengths of blue and green, and emits mixed light of the blue and green, in accordance with the current If1. As described, by adopting, as the LED light source 2, the two-wavelength LED chip 8a for emitting light having a plurality of different peak wavelengths, it is possible to simplify a circuit for driving an LED, and downsize the LED light source 2. Further, the red color LED chip 8b has an oscillation peak wavelength of a red region. Such a red color LED chip 8b emits, according to the current If2, light of red which is a complementary color for the mixed light of blue and green. Although a combination of blue and green light is able to produce light which is sufficiently white for a practical application, the white light of such a combination turns out to be somewhat bluish white. This is due to the lack of red light which is one of three primary colors of light. However, in the light emitting circuit 12 of the present embodiment, the red color LED chip 8b is provided in addition to the two-wavelength LED chip 8a. This allows expansion of an adjustable range of the chromaticity. Further, since the respective waveforms of the currents If1 and If2 are block pulse, it is possible to keep a constant luminous intensity of the LED chips 8a and 8b, during their lighting periods. Thus, it is possible to restrain flickering.

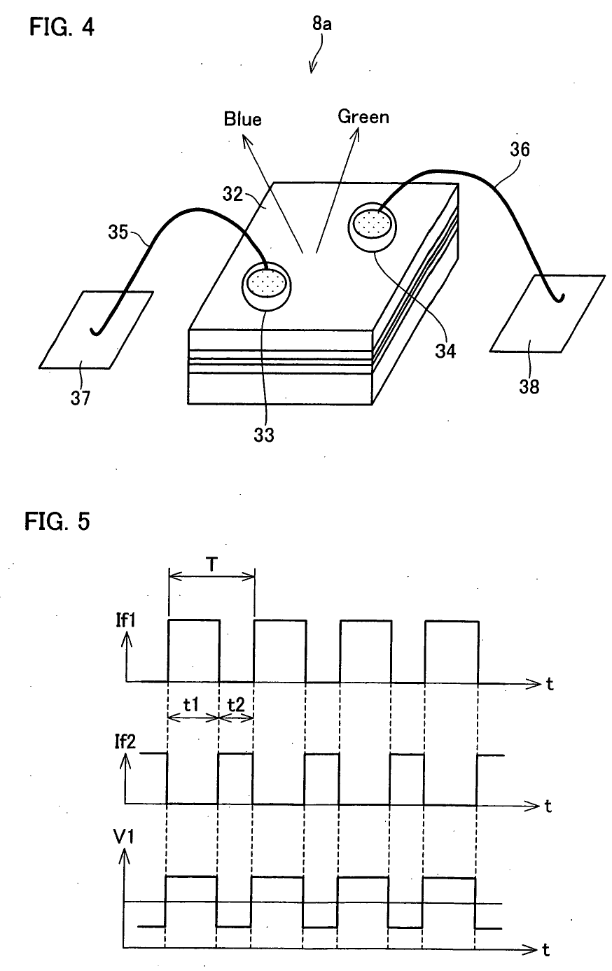

FIG. 4 is a diagram schematically illustrating an exemplary element configuration of the two-wavelength LED chip 8a. As illustrated, the two-wavelength LED chip 8a includes internal electrodes 33 and 34. The internal electrode 33 and an external electrode 37 are connected with each other via wiring 35, and the internal electrode 34 and an external electrode 38 are connected with each other via wiring 36. The wiring 35 and 36 are made of Au (gold) or the like. The two-wavelength LED chip 8a has a semiconductor multi-layered construction. The two-wavelength LED chip 8a emits blue and green light, with an application of a voltage via the external electrodes 37 and 38, the wiring 35 and 36, and the internal electrodes 33 and 34. In the two-wavelength LED chip 8a, it is possible to modify how much energy level, regarding the light emission, varies in a portion for emitting green light and a portion for emitting blue light, by (i) modifying materials used in the portions, or (ii) modifying a ratio of materials used for the portions. Thus, it is possible to differentiate, between the respective portions, the amount of respective oscillation peak wavelengths shifted for an amount of current varied. The two-wavelength LED chip 8a may be, for example, an LED chip disclosed in Japanese Unexamined Patent Publication No. 145513/1999 (Tokukaihei 11-145513).

As mentioned above, the values of the current If1 and If2 are adjustable with the use of the current determining circuits 23a and 23b, and the oscillation peak wavelengths of green and blue both shift from the long wavelength side to the short wavelength side, with the rise of the current If-1. For a change in an amount of the current, the oscillation peak wavelength of green varies more largely than the oscillation peak wavelength of blue. As such, the chromaticity of the mixed light of green and blue varies, when the oscillation peak wavelength of green shifts from the long wavelength side to the short wavelength side with an increase in the current amount, the oscillation peak wavelength of green varying more largely than the oscillation peak wavelength of blue. Note that the two-wavelength LED chip 8a is not limited to one in which the wavelength of green light varies more than that of blue light. For example, the two-wavelength LED chip 8a may be one in which the wavelength of yellow-green, yellow, or orange-red light varies more than that of blue light. The current determining circuit 23a and 23b may be fixed resistors. However, it is preferable that the current determining circuit 23a and 23b be variable resistors. Specific resistance values of the current determining circuit 23a and 23b are suitably determined in accordance with (i) the respective properties of the two-wavelength LED chip 8a and the red color LED chip 8b, and (ii) the intended chromaticity. In this case, it is possible to adjust the chromaticity and the luminous intensity, even after the LED light source 2 (luminescent circuit 12) is assembled, by varying the resistance value of the variable resistors.

The following describes how the chromaticity is adjusted and determined in the LED light source 2. First, the luminous intensity and the chromaticity are measured by supplying a predetermined current to the LED chips 8a and 8b. Alternatively, the luminous intensity and the chromaticity may be measured by varying the current supplied to the LED chips 8a and 8b. Then, based on the measurement result, the respective values of the currents If1 and If2 are determined so that a desirable luminous intensity and a desirable chromaticity are obtained. Based on thus determined current values, the resistance values of the respective resistors in the current determining circuit 23a and 23b are determined.

As described, in the present embodiment, the two-wavelength LED chip 8a which emits light of two colors, and the red color LED chip 8b which emits light of one color are alternately driven (lightened up), by using the AC power supply and the light source control circuit 20. With this configuration, the light emitting circuit 12 and the light source control circuit 20 are simplified, and the LED light source 2 is downsized.

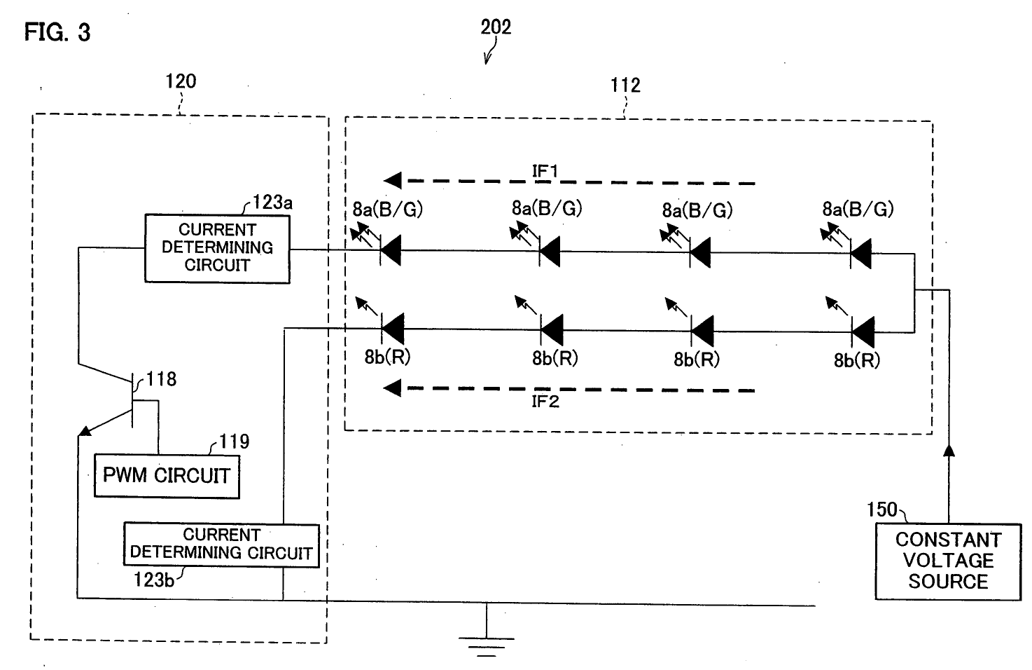

Note that the light emitting circuit may be configured as illustrated in FIG. 3. Namely, in an LED light source 202, a light source control circuit 120 is connected to a light emitting circuit 112. The light source control circuit 120 includes: a PWM (Pulse Width Modulation) circuit 119; an NPN transistor 118; and a current determining circuit 123. The light emitting circuit 112 includes four two-wavelength LED chips 8a and four red color LED chips 8b. The four two-wavelength LED chips 8a are serially connected between two nodes, and the respective electric polarities (anode-to-cathode direction) of the two-wavelength LED chips 8a are the same. One of the nodes on the side of the anode of the two-wavelength LED chip 8a is connected to a constant voltage source, and the other node on the side of the cathode of the two-wavelength LED chip 8a is connected to the NPN transistor 118 via the current determining circuit 123a. The four red color LED chips 8b are serially connected between two nodes, and the respective electric polarities (anode-to-cathode direction) of the red color LED chips 8b are the same. One of the nodes on the side of the anode of the red color LED chip 8b is connected to a constant voltage source, and the other node on the side of the cathode of the red color LED chip 8b is grounded via the current determining circuit 123b. The base of the NPN transistor 118 is connected to the PWM circuit 119, and the emitter of the NPN transistor 118 is grounded. The PWM circuit 119 applies, to the base of the NPN transistor 118, a drive voltage whose pulse width has been modulated. In this configuration, a current IF1 flows in each of the two-wavelength LED chips 8a, and a current IF2 flows in each of the red color LED chips 8b. These currents IF1 and IF2 flows in the same direction.

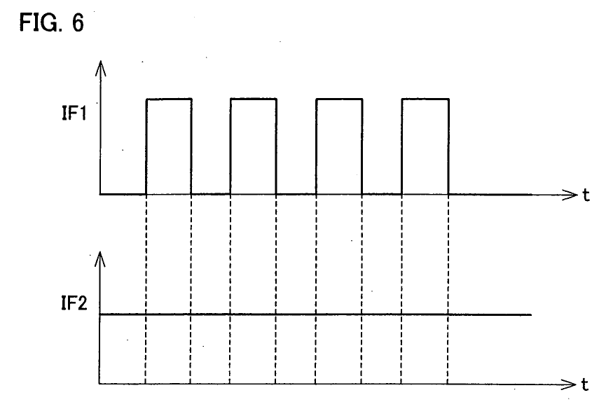

FIG. 6 is a diagram explaining how currents IF1, IF2 change over time. As illustrated in the figure, the current IF1 is a pulse current, while the current IF2 is a constant current (DC current). The current IF2 is used as a constant current for the purpose of simplifying the following adjustment works. In the present embodiment, only the current IF1 is varied, so that the circuit in the LED light source 202 are simplified.

When the adjustment of the chromaticity is carried out for the first time in the LED light source 202, the current IF1 is varied by causing a variation in the resistance value of the current determining circuit 123a. The oscillation peak wavelength of green shifts from the long wavelength side to the short wavelength side with an increase in the current IF1, the oscillation peak wavelength of green varying more largely than the oscillation peak wavelength of blue. Then, the chromaticity gradually varies, as the green light is mixed with blue light whose wavelength varies less. Then, the current IF1 is fixed at the point where the desirable chromaticity is obtained. Further, the current IF2 which flows in the red color LED chip 8b is adjusted for the purpose of achieving more desirable white color of light generated in the LED light source 202. Further, when adjusting the luminescence intensity, the lighting period of the two-wavelength LED chips 8a is controlled by adjusting the pulse width of the drive voltage to be supplied from the PWM circuit 119.

As described, in the configuration, a pulse current is used for driving the two-wavelength LED chips 8a which emits light of two colors, and a constant current is used for driving the red color LED chip 8b which emits light of one color. This configuration allows downsizing of the LED light source 202.

The following describes a configuration of the depressed portion 2x of the LED light source 2 illustrated in FIG. 1.

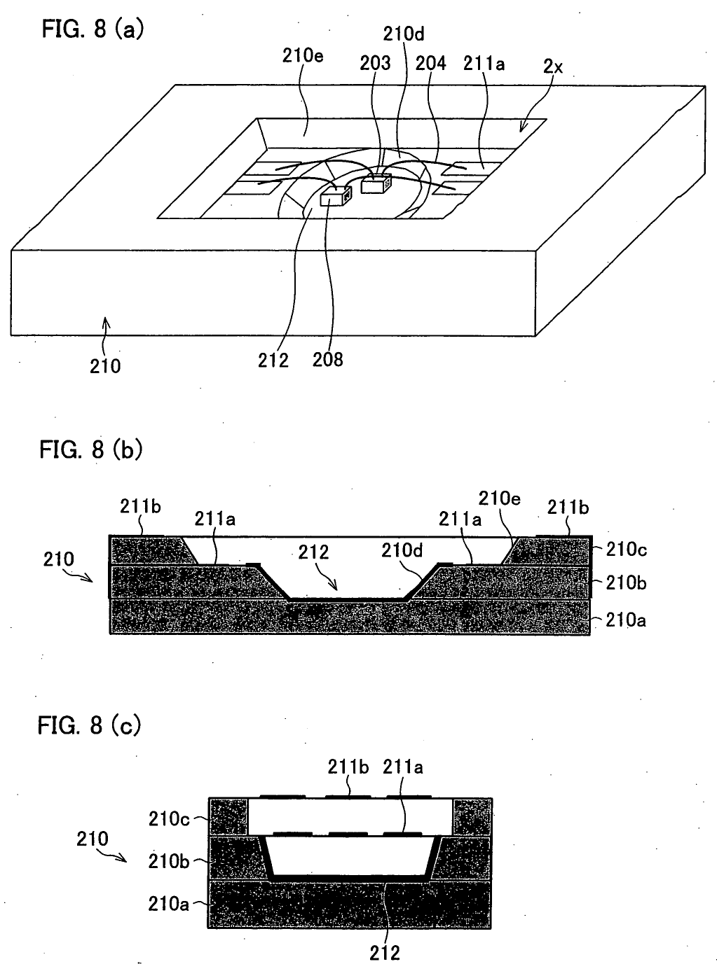

As illustrated in FIG. 8(a) to FIG. 8(c), the LED light source 2 of the present embodiment has two LEDs 203 and 208 in its depressed portion 2x. The luminous elements 203 and 208 respectively correspond to the two-wavelength LED chip 8a and the red color LED chip 8b illustrated in FIG. 1.

In the depressed portion 2x, there is provided: a ceramic substrate 210 (corresponds to module substrate 9 of FIG. 1) which is electrically insulative, and which has good thermal conductivity; a first depressed portion 210e formed, by perforating the ceramic substrate 210 in the thickness direction so that a light emitting aperture is formed on the surface of the ceramic substrate 210; a second depressed portion 210d provided in the first depressed portion 210e, for mounting therein the luminous elements 203 (two-wavelength LED chip) and the luminous element 208 (red color LED chip), the second depressed portion 210d being formed by perforating the ceramic substrate 210 in the thickness direction; and a wiring pattern 211a for supplying power to the luminous elements 203 and 208, the wiring pattern 211a being formed in the first depressed portion 210e.

Further, the depressed portion 2x includes a light-reflective metalization layer 212 which is electrically insulated from the wiring pattern 211a. This metalization layer 212 is formed on the ceramic substrate so that the metalization layer 212 is on a side, of positions for mounting the luminous elements 203 and 208 in the second depressed portion 210d, which is opposite to the light emitting aperture. The light emitting aperture is an opening end of the first depressed portion 210e which is on the surface of the ceramic substrate 210.

The following explains the depressed portion 2x, along a manufacturing process therefor. The ceramic substrate 210 is molded in a shape of substantially rectangular plate. As illustrated in FIG. 8(b) and FIG. 8(c), this ceramic substrate 210 includes multiple layers, such as three ceramic substrates 210a, 210b, and 210c, which are closely laminated in the thickness direction. The ceramic substrates 210a, 210b, and 210c are preferably made of a electrically insulative material having good thermal conductivity. Such a material can be, for example, hydrocarbon (SiC), alumina (AI203), or aluminium nitride (AIN). Since AIN has excellent thermal conductivity and moldability, it is more preferable that AIN be adopted as the material for the ceramic substrates 210a, 210b, and 210c. Electrically insulative material means a material whose resistance value (RT) is 1010 (Ω·cm) or higher, and more preferably 1012 (Ω·cm) or higher. Further, material having good thermal conductivity means a material whose thermal conductivity (RT) is 18 (W/m·k) or higher, more preferably 60 (W/m·k) or higher, and most preferably 140 (W/m·k) or higher.

The ceramic substrate 210a, 210b, and 210c are formed by: (i) filling a predetermined mold with ceramic material powder; (ii) carrying out a hot-press molding; and then (iii) carrying out a sintering process with respect to the molded product. The similar material and manufacturing method are used for another ceramic substrate described hereinbelow. Note that the foregoing ceramic substrate 210 has a multi-layered configuration. However, the ceramic substrate 210 may have a single-piece construction.

The foregoing second depressed portion 210d is formed in a tapered shape, at the center portion of the ceramic substrate 210b. More specifically, the internal diameter of the second depressed portion 210d (i.e. the width of the depressed portion in a surface direction of the ceramic substrate 210) is continuously reduced from that side of the ceramic substrate 210c, which is adjacent to a first through-hole perforated on the ceramic substrate 210b in the thickness direction, towards the side of the ceramic substrate 210a. The internal wall of the first through-hole and the surface of the ceramic substrate 210a serve as the bottom surface of the second depressed portion 210d. In terms of light reflectivity and ease of manufacturing, it is preferable that the internal shape of the second depressed portion 210d be made in a circular truncated cone shape (conical cone shape, cup-like configuration), so that the light is more likely to be reflected in the direction towards the aperture section.

Further, the foregoing first depressed portion 210e is formed in a tapered shape, at the center portion of the ceramic substrate 210c. More specifically, the internal diameter of the first depressed portion 210e is continuously increased from the side of the ceramic substrate 210b in the thickness direction of the ceramic substrate 210c, the side of the ceramic substrate 210b being adjacent to a second through-hole perforated in the thickness direction. The internal wall of the second through-hole and a surface of the ceramic substrate 210b serve as the bottom surface of the first depressed portion 210e. In other words, the second depressed portion 210d is formed on the internal bottom surface of the first depressed portion 210e.

It is preferable that the first depressed portion 210e and the second depressed portion 210d be formed so that the respective symmetrical axes (axes running in the thickness direction of the ceramic substrates 210b and 210c) of the first depressed portion 210e and the second depressed portion 210d agree with each other. Further, the internal shape of the first depressed portion 210e is preferably a truncated pyramid shape, so that the later-described wiring pattern 211 is easily arranged, and that the wiring itself can be simplified.

Further, the wiring patterns 211a for supplying power to the luminous elements 203 and 208 are formed on a peripheral part, of the ceramic substrate 210b, on the adjacent side to the ceramic substrate 210c. The each of the wiring patterns 211a is extended from a peripheral edge of the ceramic substrate 210b to such a position on the bottom surface of the first depressed portion 210e, that the wiring pattern 211a is exposed. Note, however, that the wiring pattern 211a does not reach the aperture section of the second depressed portion 210d; i.e., the wiring pattern 211a is extended up to a position immediately before the aperture section, at the longest.

With this configuration, the power is supplied to the luminous elements 203 and 208 (two-wavelength LED chip 8a and Red color LED chip 8b), via the wiring patterns 211a.

Further, in the depressed portion 2x, a metalization (metal) layer 212, whose thermal conductivity is better (higher) than that of the ceramic substrates 210a, 210b, and 210c, is formed on at least a part of the second depressed portion 210d, on which the luminous elements 203 and 208 are mounted. The material for the metalization layer 212 is not particularly limited as long as the material has excellent light reflectivity and good thermal conductivity. For example, the metalization layer 212 may be formed by silver (Ag) plating.

It is preferable that the metalization layer 212 have such a light reflectivity that 50% (more preferably 70%) of light incident thereto is reflected. Further, in the present embodiment, the metalization layer 212 is preferably formed through out the surface of the second depressed portion 210d. Further, the metalization layer 212 may be formed in a hem-like manner, flange-like manner, or a radial manner so that the metalization layer 212 is outwardly extended from the inside of the first depressed portion 210d, provided that the metalization layer 212 is apart from the wiring patterns 211a, and is electrically insulated from the wiring patterns 211a. The material and formation method of the following metalization layer is the same as those of the above described metalization layer 212, unless otherwise notified.

Further, another configuration of the LED light source 2 is described below.

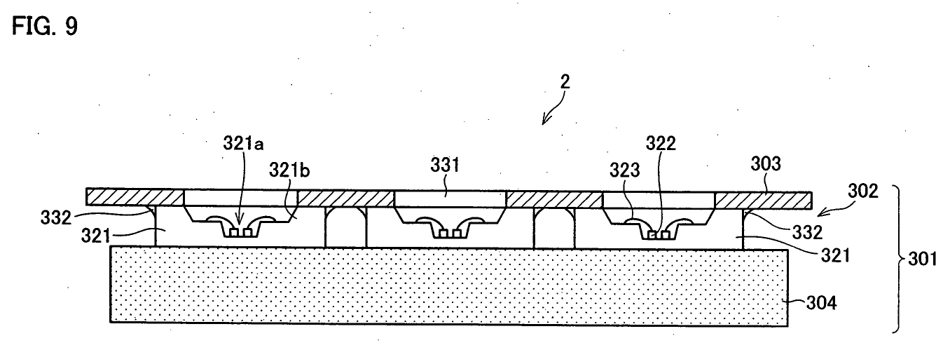

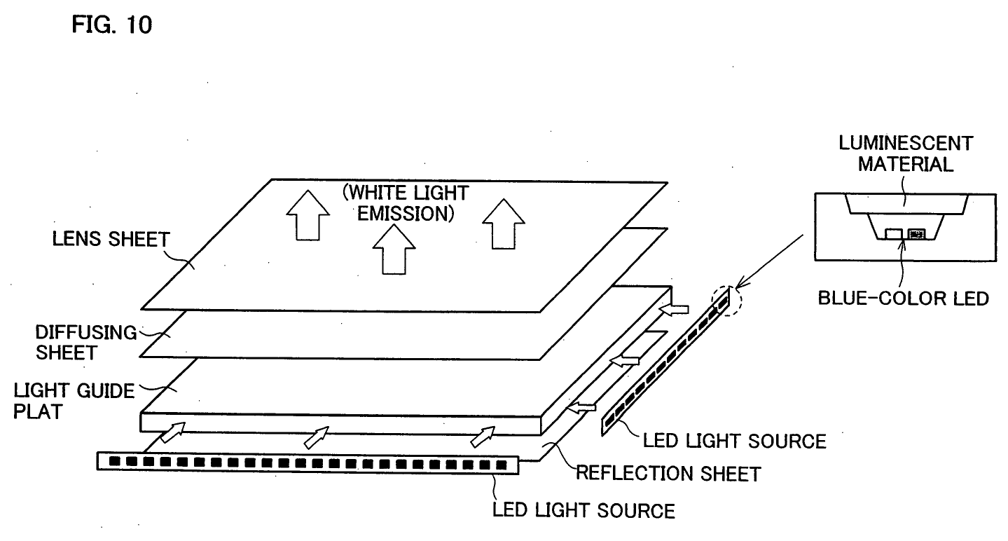

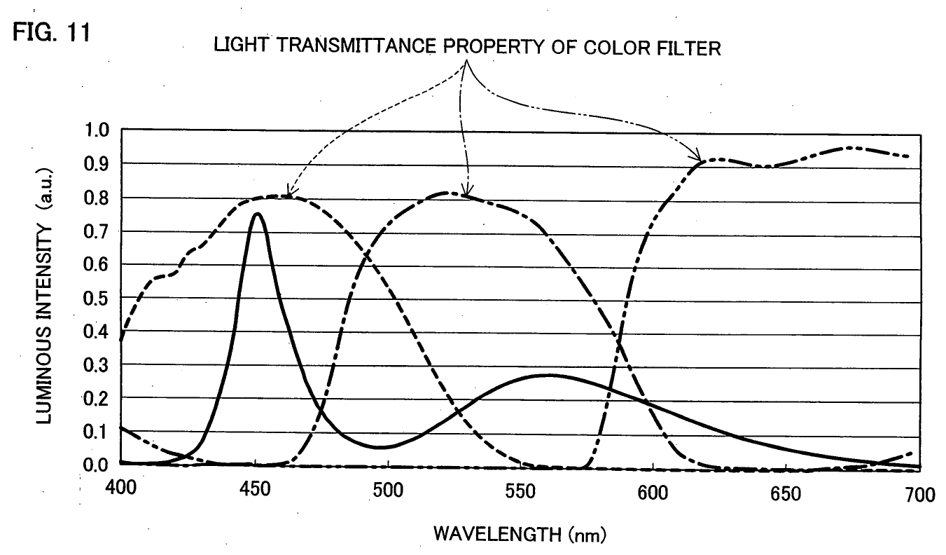

FIG. 9 is a cross sectional view illustrating a configuration of an LED light source of the present invention. In FIG. 9, the LED light source 2 includes: an LED element substrate 302 on which one or more luminous element mounting boards are aligned, at a predetermined pitch, in one or more lines; a connection substrate 303 provided above the LED element substrate 302; and a heat dissipating element 304 serving as a heat dissipating member such as a heat sink, the heat dissipating element 304 provided on the bottom face of the LED element substrate 302.

The LED element substrate 302 includes: a ceramic substrate 321 (corresponding to module substrate 9 of FIG. 1) serving as a luminous element mounting board; an LED chip 322 (corresponding to the two-wavelength LED chip 8a and the red color LED chip 8b of FIG. 1) serving as a luminous element which is a source of luminance, the LED chip 322 being provided to the ceramic substrate 321; and connection wiring 323 (wiring line) for use in connecting each of the LED chips 322 with a predetermined position of the wiring pattern (not shown) on the ceramic substrate 321.

The ceramic substrate 321, which has a good thermal conductivity, includes a depressed portion in a center portion of one of its surfaces. This depressed portion has a two-stage configuration which includes a deep depressed portion 321a provided in the center portion; and a shallow depressed portion 321b formed around the deep depressed portion 321a. One or more LED chips 322, at least one of which being capable of emitting light of two different colors, are arranged in the deep depressed portion 321a. Each of the LED chips 322 is arranged so that its back face which is opposite to its light emitting side faces the ceramic substrate 321. Further, each LED chip 322 is die-bonded on a predetermined position of a wiring pattern (not shown) provided in the deep depressed portion 321a. An electrode on the light emitting surface of the each LED chip 322 is wire-bonded, by using the connection wiring 323, on a predetermined position on the wiring pattern (not shown) provided on the shallow depressed portion 321b.

The connection substrate 303 includes a plurality of window sections 331 serving as a light transmitting section, for transmitting or let passing light from the LED element substrate 302. Each of the window sections 331 are arranged so that the window sections 331 respectively correspond to the LED chips 322 or the depressed portion of the plurality of the ceramic substrates 321 arranged below the connection substrate 303. Each of the window sections 331 restrains the dispersion of the light from the LED chip 322. Further, on the connection substrate 303, a wiring pattern (not shown) for supplying a current to the LED chip 322 and a wiring pattern (not shown) on a top surface of the light emitting side of the ceramic substrate 321 are connected by solder 332 or the like.

The top surface of the heat dissipating element 304 is bonded with a surface (i.e. the back surface having no electrically conductive pattern), of the ceramic substrate 321, which is opposite to the light emitting side of the ceramic substrate 321. With this configuration, the heat generated by the LED chip 322 is transferred to the heat dissipating element 304, only via (i) the ceramic substrate 321, and (ii) the adhesive agent which die-bonds the ceramic substrate 321 with the LED chip 322. This realizes a remarkably improved thermal conductivity, when compared to a conventional configuration in which the heat dissipating element 304 and the LED chip 322 interpose therebetween a resin substrate and a connection substrate. Thus, it is possible to more efficiently dissipate the heat.

As described, with a light source module of the present invention, light of two colors (e.g., blue and green) is emitted from one luminous element, so that light (backlight for a display device) of a white color which is a mixed color of these two colors is obtained. When compared to a light source module configured only by a single color luminous element, the light source module of the present invention allows downsizing of a circuit for driving (causing light emission from) the luminous element, and allows a simple wiring of the circuit pattern. Thus, the light source module is downsized. Further, since the circuit is downsized, it is possible to add another color of luminous element. In this case, white color light can be obtained by mixing three colors (i.e. blue, green, and red), which consequently improves the color reproducibility via a color filter.

Here, the light source module of the present invention is preferably adapted so that a predetermined peak wavelength is shifted by adjusting a driving current which causes the luminous element to emit light. In this way, it becomes possible to adjust chromaticity to a desirable chromaticity simply by adjusting the driving current. Further, the configuration is convenient in terms of color adjustment, since the color adjustment is possible even after the light source module is assembled.

Further, the light source module of the present invention is adapted so that the luminous element serves as a first luminous element for emitting light having two peak wavelengths, said light source module further comprising a second luminous element for emitting light having a peak wavelength which is different from the two peak wavelengths. This configuration allows production of white light by mixing three colors (e.g. blue, green, and red). As a result, the color reproducibility via a color filter is improved.

Further, the light source module of the present invention is preferably adapted so that the two peak wavelengths of the first luminous element are a wavelength in a blue region and a wavelength in a green region; and the wavelength of the second luminous element is a wavelength in a red region. This configuration is suitable for a color filter for typical three colors of R, G, and B.

Further, the light source module of the present invention is preferably adapted so that: the first luminous element emits light while a first driving current flows in the first luminous element; and the second luminous element emits light while a second driving current flows in the second luminous element. By separately driving the first and the second luminous elements, it is possible to optimize the driving of each luminous element.

Further, the light source module of the present invention is preferably adapted so that flowing of the first driving current in the first luminous element and flowing of the second driving current in the second luminous element are alternately carried out. This allows a parallel connection of the first and the second luminous elements, and driving of the thus connected luminous elements. This is advantageous in downsizing (simplifying) a circuit for use in driving the luminous element.

Further, it is preferable that the light source module of the present invention further include an adjustment circuit for adjusting the first driving current and the second driving current. This configuration allows adjustment of a mixed color, even after the light source module is assembled, by adjusting the first and the second driving currents.

Further, it is preferable that the light source module of the present invention further include a determining circuit for determining a first time period and a second time period in a predetermined period, the first time period being a period during which the first driving current flows, and the second time period being a period during which the second driving current flows. This configuration allows adjustment of respective lighting periods of the first and the second luminous elements. Further, the configuration allows adjustment of luminous intensity of the light source module even after the light source module is assembled.

Further, the light source module of the present invention is preferably adapted so that the determining circuit determines the first time period and the second time period so that a ratio of the first time period to the second time period is one or more. Since the first luminous element alone emits light of two colors, the brightness of each color tends to be low. In view of that, the lighting period of the first luminous element within the predetermined period is extended; i.e. a high duty ratio is raised. This allows production of a mixed color at a desirable brightness.

Further, the light source module of the present invention is preferably adapted so that the first and the second driving currents flow in an alternating manner. This simplifies a configuration of a circuit for driving the luminous elements.

Further, the light source module of the present invention is preferably adapted so that the first luminous element is a first light emitting diode having the two peak wavelengths which are a peak wavelength in a green region and a peak wavelength in a blue region; and the second luminous element is a second light emitting diode having a peak wavelength in a red region.

Further, the light source module of the present invention is preferably adapted so that the first and the second light emitting diodes are connected in parallel between two nodes so that an electric polarity of the first light emitting diode and an electric polarity of the second light emitting diode are opposite to each other.

Further, it is preferable that the light source module of the present invention further include: a ceramic substrate which is electrically insulative, and which has a thermal conductivity; a first depressed portion so formed in a thickness direction of the ceramic substrate that a light emitting aperture is formed on a surface of the ceramic substrate; a second depressed portion, for mounting thereon the luminous element, formed within the first depressed portion in the thickness direction of the ceramic substrate; a wiring pattern, which is formed in at least one of the first depressed portion and the second depressed portion, for supplying power to the luminous element; and a light reflective metalization layer formed in the second depressed portion on the ceramic substrate so that the metalization layer is on a side, of a luminous element mounting position, which is opposite to the light emitting aperture. Further, the light source module of the present invention may include a ceramic substrate which is electrically insulative, and which has a thermal conductivity, wherein the ceramic substrate includes a first depressed portion and a second depressed portion formed in the first depressed portion, the first and second depressed portions being formed in the thickness direction of the ceramic substrate, a wiring pattern is formed in at least one of the first depressed portion and the second depressed portion, a metalization layer is formed on a bottom portion of the second depressed portion, the luminous element is provided in the second depressed portion, and an aperture of the first depressed portion serves as a light emitting aperture. This configuration restrains an increase in a temperature of the light source module.

Further, it is preferable that the light source module of the present invention further include a substrate having the luminous element on its front surface; and a heat dissipating member connected at least one of a back surface and side surfaces of the substrate, the luminous element and the heat dissipating member having therebetween only the substrate and an adhesive agent for die-bonding the luminous element and the substrate. This configuration restrains an increase in a temperature of the light source module.

Further, a backlight unit of the present invention includes the foregoing light source unit.

Further, a liquid crystal display device of the present invention includes the backlight unit.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

A light source module of the present invention is suitably applicable to various display devices such as a mobile phone, a PDA (Personal Digital Assistance), an instrument panel of an auto mobile, a monitor, a television set, or the like.

What is claimed is:

1. A light source module for use in a backlight unit of a display device, comprising a luminous element for emitting light having at least two peak wavelengths.

2. The light source module as set forth in claim 1, wherein a predetermined peak wavelength is shifted by adjusting a driving current which causes the luminous element to emit light.

3. The light source module as set forth in claim 1, wherein:
the luminous element serves as a first luminous element for emitting light having two peak wavelengths,
said light source module further comprising a second luminous element for emitting light having a peak wavelength which is different from the two peak wavelengths.

4. The light source module as set forth in claim 3, wherein:
the two peak wavelengths of the first luminous element are a wavelength in a blue region and a wavelength in a green region; and
the wavelength of the second luminous element is a wavelength in a red region.

5. The light source module as set forth in claim 3, wherein:
the first luminous element emits light while a first driving current flows in the first luminous element; and
the second luminous element emits light while a second driving current flows in the second luminous element.

6. The light source module as set forth in claim 5, wherein flowing of the first driving current in the first luminous element and flowing of the second driving current in the second luminous element are alternately carried out.

7. The light source module as set forth in claim 5, further comprising an adjustment circuit for adjusting the first driving current and the second driving current.

8. The light source module as set forth in claim 6, further comprising
a determining circuit for determining a first time period and a second time period in a predetermined period, the first time period being a period during which the first driving current flows, and the second time period being a period during which the second driving current flows.

9. The light source module as set forth in claim 8, wherein the determining circuit determines the first time period and the second time period so that a ratio of the first time period to the second time period is one or more.

10. The light source module as set forth in claim 6, wherein the first and the second driving currents flow in an alternating manner.

11. The light source module as set forth in claim 3, wherein
the first luminous element is a first light emitting diode having the two peak wavelengths which are a peak wavelength in a green region and a peak wavelength in a blue region; and
the second luminous element is a second light emitting diode having a peak wavelength in a red region.

12. The light source module as set forth in claim 11, wherein the first and the second light emitting diodes are connected in parallel between two nodes so that an electric polarity of the first light emitting diode and an electric polarity of the second light emitting diode are opposite to each other.

13. The light source module as set forth in claim 1, further comprising:
a ceramic substrate which is electrically insulative, and which has a thermal conductivity;
a first depressed portion so formed in a thickness direction of the ceramic substrate that a light emitting aperture is formed on a surface of the ceramic substrate;
a second depressed portion, for mounting thereon the luminous element, formed within the first depressed portion in the thickness direction of the ceramic substrate;
a wiring pattern, which is formed in at least one of the first depressed portion and the second depressed portion, for supplying power to the luminous element; and
a light reflective metalization layer formed in the second depressed portion on the ceramic substrate so that the metalization layer is on a side, of a luminous element mounting position, which is opposite to the light emitting aperture.

14. The light source module as set forth in claim 1, further comprising:
a ceramic substrate which is electrically insulative, and which has a thermal conductivity, wherein
the ceramic substrate includes a first depressed portion and a second depressed portion formed in the first depressed portion, the first and second depressed portions being formed in the thickness direction of the ceramic substrate,
a wiring pattern is formed in at least one of the first depressed portion and the second depressed portion,
a metalization layer is formed on a bottom portion of the second depressed portion,
the luminous element is provided in the second depressed portion, and
an aperture of the first depressed portion serves as a light emitting aperture.

15. The light source module as set forth in claim 1, further comprising:
a substrate having the luminous element on its front surface; and
a heat dissipating member connected at least one of a back surface and side surfaces of the substrate,
the luminous element and the heat dissipating member having therebetween only the substrate and an adhesive agent for die-bonding the luminous element and the substrate.

16. A backlight unit including a light source module, wherein the light source module includes a luminous element for emitting light having at least two peak wavelengths.

17. A liquid crystal display device including a backlight unit having a light source module, wherein
the light source module includes a luminous element for emitting light having at least two peak wavelengths.
